(19) United States
(12) Patent Application Publication
(10) Pub. No.: US 2013/0312063 A1
(43) Pub. Date: Nov. 21, 2013

(54) SECURE NETWORK CONNECTION

(71) Applicants: Caroline JACTAT, Berkshire (GB); Vincent ROGER, Berkshire (GB); Antoine VALLEE, Berkshire (GB); Anand Raghawa PRASAD, Tokyo (JP)

(72) Inventors: Caroline JACTAT, Berkshire (GB); Vincent ROGER, Berkshire (GB); Antoine VALLEE, Berkshire (GB); Anand Raghawa PRASAD, Tokyo (JP)

(73) Assignee: NEC CORPORATION, Tokyo (JP)

(21) Appl. No.: 13/952,105

(22) Filed: Jul. 26, 2013

Related U.S. Application Data
(63) Continuation of application No. 13/381,266, filed on Dec. 28, 2011.

(30) Foreign Application Priority Data
Jun. 29, 2009 (GB) 0911117.0

(51) Int. Cl. H04W 12/08

(52) U.S. Cl. CPC H04W 12/08
USPC 726/3

(57) ABSTRACT

The invention provides for a method for use in a mobile radio communications network connection procedure and including the step of rejecting at a mobile radio communications device a handover request from a network responsive to determination of support of the security algorithm associated with the handover, and for a mobile radio communications device arranged to determine support of security algorithms as proposed by the network, preferably at AS level, within a handover command, and to provide notification to the network of rejection of the connection due to non-support of the algorithm.

This application is a Continuation Application of U.S. application Ser. No. 13/381,266 filed Dec. 28, 2011, which is a National Stage of International Application No. PCT/JP2010/060595 filed Jun. 16, 2010, claiming priority from United Kingdom Patent Application No. 0911117.0 filed Jun. 29, 2009, the disclosures of which are incorporated herein by reference in their entirety.

### TECHNICAL FIELD

The present invention relates to a method for use in mobile radio communications network connection, and to a mobile radio communications device, and network device, arranged to achieve such connection.

### BACKGROUND ART

For mobile radio communication devices such as User Equipment (UE) handsets operating in relation to mobile communication networks, various security-related procedures arise at the time of seeking network connection, whether at the time of initial connection or when the UE is required to handover from one network to another. Such handover procedures can involve handovers between different network technologies particularly as communication systems and there underlying technologies evolve.

Security algorithms are generally provided in order to achieve, and maintain, ongoing secure communication between the UE and the network and it is quite common for the Core Network (CN) to provide the required security algorithm on the basis of the security capabilities of the UE.

Problems and potential limitations have however been found to arise due to the potential for different security algorithms and, in particular, subsequent to a change in algorithm due to an upgrade or otherwise such that a UE and a network device are not both fully upgraded for use solely with a new algorithm.

The security of ongoing data transfer can then be compromised through the ongoing use of the possibly out of date, or unsupported, and so possibly comprised, algorithm. Various network systems and devices are known relating to security issues and, in particular, security algorithm creation and negotiation such as, for example, found in Chinese Patent Applications CN101242360, CN101374153, CN101222320 and U.S. Patent Application U.S. 2006/294575.

While aspects of network security are covered by these earlier applications, none seeks to address the problems now identified and as overcome by the present invention concerning the use of old and potentially unsupported algorithms.

### DISCLOSURE OF INVENTION

The present invention seeks to provide for a network connection method, and related mobile radio communication and network devices having advantages over known such methods and devices and which, in particular, can offer a high degree of ongoing security subsequent to a connection procedure executed by the mobile radio communications device.

According to a first aspect of the present invention, there is provided a method for use in a mobile radio communications network connection procedure and including the step of rejecting at a mobile radio communications device a handover request from the network responsive to determination of the support of the security algorithm associated with the handover.

The invention can prove advantageous insofar as the mobile radio communications device does then not automatically accept the handover request and so as serves to limit the danger that the subsequent data exchange between the mobile radio communications device and the network might make use of an older, and possibly now compromised, security algorithm.

The method finds particular use in the situation involving determining the support of the security algorithm as proposed by the network.

Commonly, the security algorithm will be proposed at the Access Stratums (AS) level within the network and so the present invention can prove particularly advantageous in achieving resilience in the AS and in relation to possibly unsupported security algorithms.

Preferably, it is found that the algorithm can be proposed by the network within a handover command derived therefrom.

Yet further, the method can include the step of providing notification from the mobile radio communications device to the network of a connection failure due to non-support of the security algorithm.

In one particular embodiment, the security algorithm comprises an Evolved Packet System (EPS) security algorithm.

Further, the method can advantageously be employed in situations where only the network is initially arranged to support an upgraded algorithm or, conversely, where only the mobile radio communications device is arranged to initially operate with an upgraded algorithm.

According to one particular aspect, the method further includes the step of initiating within the network, a handover procedure with a second algorithm different from the algorithm determined as not supported.

In particular, the method can include the step of re-initiating a handover procedure within the network.

According to another aspect of the present invention, there is provided a mobile radio communications device arranged to determine support of security algorithms therein and further arranged to reject a network connection request responsive to said determination of the support of the security algorithm.

As noted above in relation to the method of the present invention, the mobile radio communications device can be arranged to receive details of a security algorithm as proposed by the network, preferably at AS level and, generally, within a handover command.

The mobile radio communications device can of course be further arranged so as to provide notification to the network serving to indicate that rejection of the connection is responsive to the determined non-support of the security algorithm.

Still further, the invention can provide for a mobile radio communications network device forming part of a network for achieving connection to a mobile radio communications device as outlined above, the network device being arranged to receive a connection-rejection notification from the mobile radio communications device and to re-initiate a connection procedure with a second security algorithm different from the un-supported algorithm.

As will be appreciated, the present invention provides for a method for use in a mobile radio communications network and, in particular, in relation to UE and network devices, in which the valid support of a security algorithm in at least one of the UE or network device is determined, and wherein the UE can reject an attempted network connection responsive to a determination that the proposed security algorithm might be unsupported so as to allow for re-initiation of the network connection on the basis of a different, and possibly supported, security algorithm.

The invention proves particularly useful when, for example, network connection of a UE to an EPS network is required and on the basis of UE EPS security capabilities.

### BRIEF DESCRIPTION OF THE DRAWINGS

The present invention is described further hereinafter by way of example only, with reference to the accompanying drawings in which:

FIG. 1 is a signalling diagram for a UE and an associated EPS network and employing signalling arising in accordance with a method embodying the present invention;

FIG. 2 is a block schematic diagram of a mobile radio communications device UE embodying the present invention; and

FIG. 3 is a block schematic representation of a network device according to one aspect of the present.

### BEST MODE FOR CARRYING OUT THE INVENTION

As discussed further below, the illustrated examples of the present invention are illustrated in relation to an attempted handover procedure to an EPS network and involving determination of the relevance, and degree of support, of the Long Term Evolution (LTM) algorithms at AS level as proposed by the network in the AS handover command.

The particular illustrated embodiment of the present invention seeks to overcome the disadvantages as hereinbefore discussed in relation to the current art and, as a particular example of such limitations, as found at the time of connection of a UE to an EPS network.

Within such known scenario, and at the time of such connection, the CN is arranged to provide a required security algorithm on the basis of the UE EPS security capabilities and in order to secure communication with the UE.

However, there may be instances in which the CN has no knowledge of the UE EPS security capabilities, for example if the UE is handed-over from a legacy network such that the security algorithm is not supported anymore by the UE, any ongoing communication between the UE and the network is then no longer able to benefit from the potential security offered by the algorithm and so such communication continues in a unsecure manner. That is, the ongoing subsequent communication between the UE and the network is based on an out-of-date EPS security algorithm which, even if providing some level of security, offers far from optimum security.

Within the context of the present application, a so-called “new” UE or network is considered to be a UE or network that no longer supports an old security algorithm inasmuch as it has been upgraded to support a new security algorithm that is available. Conversely, an “old” UE or network is a UE or a network that still supports an old security algorithm even though possible updates are available.

Of course, it should be appreciated that such a security algorithm can be related to “integrity protection” or “ciphering” and, as examples, a default set of EPS security algorithms comprises:

AES based algorithm for encryption such as EA0 NULL algorithm, 128-EEA1; and SNOW 3G based algorithm and 128-EEA2.

While examples of an AES for integrity protection comprise 128-EIA1 SNOW 3G and 128-EIA2.

It should be appreciated that a so-called old algorithm can form part of the default set of EPS security algorithms (for example from 3GPP Release 8) or can be part of 3GPP Release 8 version.

That is, when connection to a UE is required from a pre-Release 8 network which does not have up-to-date UE EPS security capabilities, in order to perform a handover from a non-EPS network, the UE will accept the handover thereby leading to the possibility that the data subsequently exchanged between the UE and the network employs the older, and not fully supported, security algorithm which can of course represent a potential security compromise.

As noted above, and as will be discussed further below, the invention provides for a method allowing for terminal equipment such as UE to reject the requested connection towards a 3GPP LTE access technology if it no longer supports the required EPS AS security algorithm and, in particular, while the network itself has been upgraded not to support that algorithm. The method advantageously includes a notification from the UE to the network, so that the network can subsequently attempt reconnection to the UE and that might already be upgraded so as not to support a particular algorithm, through the selection of a different EPS security algorithm from that found as part of the initial connection request.

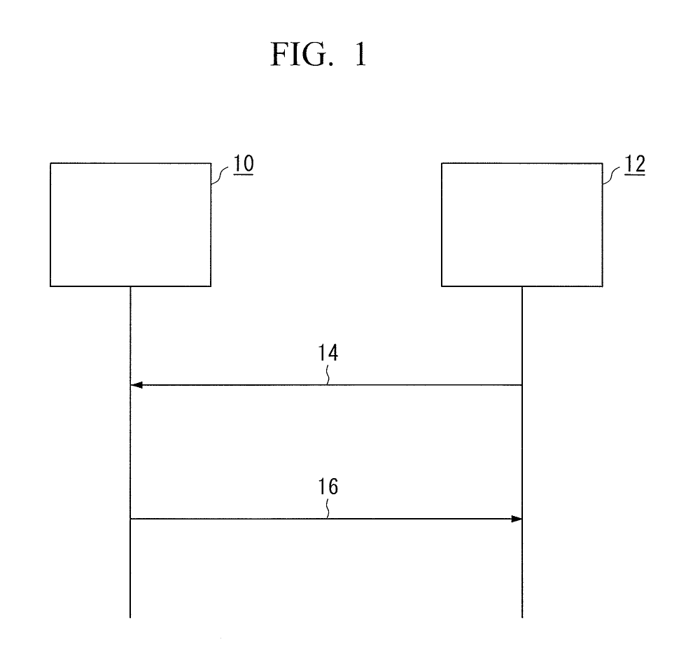

Turning now to FIG. 1, there is illustrated a signal timing diagram concerning signalling messages relevant to the present invention and arising between a UE 10 and a network 12. In this example, the UE 10 comprises a “new” UE insofar as it has been upgraded to support a new security algorithm, and the network comprises an “old” network 12 which has not yet been upgraded and so only supports an older security algorithm.

At the start of an attempted handover procedure to the network 12, an AS handover command 14 is issued from the network 12 to the UE 10.

Although not illustrated, the AS handover command 14 comprises an AS security container including an AS selected security algorithm and also a NAS security container.

In accordance with the present invention, the UE 10 is arranged to check the LTE algorithms at the AS level and as proposed by the network within the AS handover command signal 14. Having identified the old (and now unsupported at the UE 10) algorithms of the network 12, the UE 10 rejects the requested AS handover. Such rejection is embodied within an AS handover failure message signal 16 which, in accordance with the particular illustrated embodiment of the present invention, includes a “cause value” so that the network 10 can readily infer that the connection was rejected to an unsupported security algorithm.

That is, the AS handover failure signalling message 16 has a “failure cause” portion indicating the presence of an (unwanted AS security algorithm)—meaning generally that the algorithm is unsupported in the UE 10.

The provision of such a failure cause element within the handover failure signalling 16 allows the network 12 to re-initiate a handover procedure and select a different AS security algorithm from that indicated in the previous AS handover command message 14.

Of course, it should be appreciated that such procedure can continue until an appropriate, or potentially most appropriate, security algorithm is indicated within the AS handover command 14 for subsequent use.

A particularly advantageous aspect of the present invention is that there is provided within the signalling an indication as to the rejection of the AS handover and, of course, such indication relating to the presence of an unsupported EPS security algorithm.

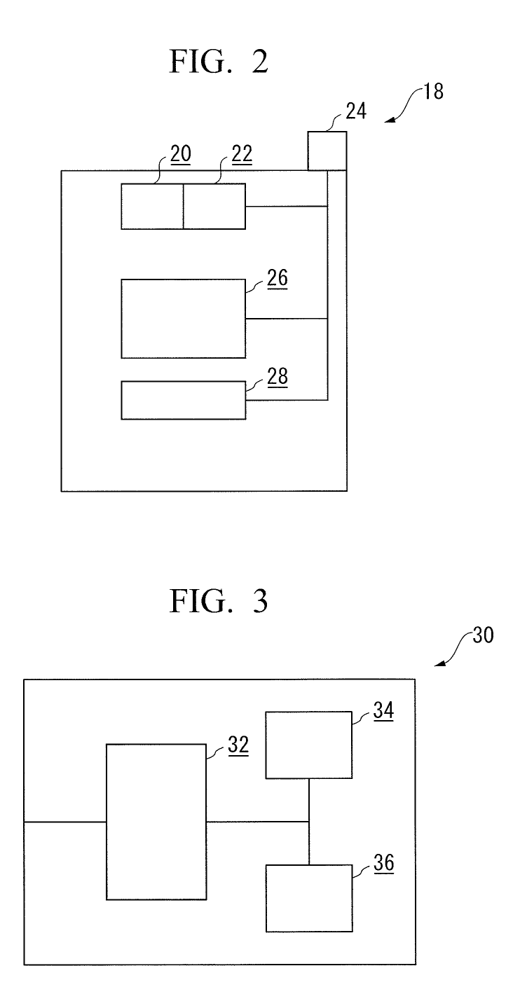

Turning now to FIG. 2, there is provided a schematic representation of a UE device handset 18 for use in accordance with the present invention.

The handset includes standard transmission 20, reception 22 functionality associated with a handset antenna 24 and standard processing 26 and memory 28 capabilities.

In accordance with the present invention however, the processing 26 capability of the invention includes means for determining at least the level of support of a security algorithm as proposed in the network signalling and arranged to initiate rejection of a connection request responsive to the results of such determination of the security algorithm.

Of course, and as will be appreciated from the above, the processing 26 functionality of the UE handset 18 provides an indication of rejection that identifies the lack of full support of the security algorithm as a reason for the rejection.

Associated with such a UE 18 of FIG. 2 within the network there is provided a network device such as that illustrated in FIG. 3.

FIG. 3 comprises a schematic block diagram representation of an appropriate network element 30 having transceiver functionality 32 and standard processing 34 and memory 36 functionality.

For the network element 30, the processing 34 functionality includes means for receiving a connection rejection communication such as that to be provided by the handset 18. Importantly, and having identified the reason for such a failure, the processing 34 functionality is arranged to re-initiate a connection procedure from the network element 30 to, for example, the UE 18 of FIG. 2 such as, for example, by way of a re-initiated AS handover, and such as the command 14 illustrated in relation to FIG. 1.

As will therefore be appreciated, the various communication and network devices, and method of operation provided by the present invention, are advantageous in providing an improved degree of resilience in the AS functionality in relation to unsupported EPS security algorithms. Of course, it should be appreciated that the invention is not restricted to the details of the specific foregoing input elements insofar as any appropriate connection scenario can benefit from the present invention and not merely the LTE handover procedure illustrated.

Through use of the present invention, subsequent communication between the UE and the network is generally based only upon supported security algorithms to thereby advantageously maintain security for subsequent communication.

### INDUSTRIAL APPLICABILITY

The present invention can be applied to a network connection method, mobile radio communication and network devices. According to the network connection method, mobile radio communication and network devices, it is possible to offer a high degree of ongoing security subsequent to a connection procedure executed by the mobile radio communications device.

1. A method for use in a mobile radio communications network connection procedure, the method including the step of rejecting at a mobile radio communications device a handover request from a network responsive to determination of the support of the security algorithm associated with the handover.

2. A method as claimed in claim 1, further including the step of determining the support of the security algorithm as proposed by the network.

3. A method as claimed in claim 2, wherein the security algorithm is proposed at the Access Stratums level within the network.

4. A method as claimed in claim 1, wherein the algorithm is proposed by the network by way of a handover command.

5. A method as claimed in claim 1, further including the step of providing notification from the mobile radio communications device to the network of connection failure due to non-support of the security algorithm.

6. A method as claimed in claim 1, wherein only one of the network or the mobile radio communications device is initially arranged to support or operate with an upgraded algorithm.

7. A method as claimed in claim 1, further including the step of initiating within the network, a handover procedure with a second algorithm different from the unsupported algorithm.

8. A method as claimed in claim 1, further including the step of re-initiating a handover procedure within the network.

9. A mobile radio communications device arranged to determine support of security algorithms therein and further arranged to reject a network connection request responsive to said determination of the support of the security algorithm.

10. A device as claimed in claim 9, and arranged to receive details of a security algorithm as proposed by the network.

11. A device as claimed in claim 10, and arranged to receive said details within a handover command.

12. A device as claimed in claim 9, and further arranged so as to provide notification to the network of the rejection of the connection.

13. A mobile radio communications network device forming part of a network for achieving connection to a mobile radio communications device and arranged to receive a connection-rejection notification from the mobile radio communications device due to an unsupported algorithm and to re-initiate a connection procedure with a second security algorithm different from the un-supported algorithm.
